(19) United States
(12) Patent Application Publication
(10) Pub. No.: US 2010/0190596 A1
(43) Pub. Date: Jul. 29, 2010

(54) Quiet Sprocket Device

(76) Inventor: Norman Wills, Mississauga (CA)

Correspondence Address: ELIAS BORGES, 56 Aberfoyle Crescent, Suite 840, Canada, ON, M8X2W4, CA

(21) Appl. No.: 12/360,268

(22) Filed: Jan. 27, 2009

(51) Int. Cl. F16H 7/06

(52) U.S. Cl. 474/154

(57) ABSTRACT

The present invention is an improved ball-chain drive which is quiet and less prone to jamming. The ball-chain drive includes a sprocket having a plurality of regularly spaced peripheral pockets, the pockets being configured to mesh with the balls of the ball chain. The pockets of the sprocket are each dimensioned to snugly receive each of the balls of the ball-chain. In particular, the pockets each have an internal circumference greater than 180° of the external circumference of each of the balls. The balls in the ball-chain are separate from each other by a segment of cord. The pockets of the sprocket are separated from each other by a plurality of walls, each wall having a V shaped notch formed thereon having sides and a meniscus. The pockets and the V shaped notch both being dimensioned such that the segments of cord do not touch the sides of the V shaped notch when the ball-chain is wound onto the sprocket.

### FIELD OF THE INVENTION

The invention relates generally to ball-chain drives for rolling and unrolling blinds.

### BACKGROUND OF THE INVENTION

Ball-chain drives have been used in roller blinds for many years to control the rolling and unrolling of roller blinds. Typical ball-chain drives consist of a sprocket mounted to a drive spindle which is in turn coupled to the roller. A ball chain is coupled to the sprocket. The sprocket is provided with a plurality of pockets formed on its periphery which are dimensioned and configured to mesh with the balls (or beads) of the ball-chain coupled to the sprocket. Pulling on the ball-chain causes the sprocket to rotate which in turn causes the blind to be rolled up or un rolled, as the case may be.

While ball-chain drives are economical and efficient, they suffer from one draw back. In the process of pulling on the ball-chain, the sprocket and ball-chain have a tendency to create a rattling sound which can be annoying to some users, particularly if the roller blind is a premium item. Furthermore, ball-chain drives occasionally have a tendency to jam, particularly where the ball-chain becomes detached from the sprocket. A ball-chain and sprocket combination which is quiet to operate and which is less prone to jamming is therefore required.

### SUMMARY OF THE INVENTION

In accordance with one aspect of the present invention, there is provided an improved ball-chain drive for use with a roll-up blind which is both quiet and less prone to jamming. The improved ball-chain drive includes a sprocket having a plurality of regularly spaced peripheral pockets, the pockets being configured to mesh with the balls of the ball chain. The pockets of the sprocket are each dimensioned to snugly receive each of the balls of the ball-chain. In particular, the pockets each have an internal circumference greater than 180° of the external circumference of each of the balls.

In accordance with another aspect of the present invention, there is provided an improved ball-chain sprocket combination for use with a roll-up blind which is both quiet and less prone the jamming. The improved ball-chain drive includes a ball-chain consisting of a cord with a plurality of regularly spaced spherical balls formed thereon, each of the balls being separate by a segment of cord. The drive further includes a sprocket having a plurality of regularly spaced peripheral pockets, the pockets being configured to mesh with the balls of the ball chain. The pockets are separated from each other by a plurality of walls, each wall having a V shaped notch formed thereon having sides and a meniscus. The pockets and the V shaped notch both being dimensioned such that the segments of cord do not touch the sides of the V shaped notch when the ball-chain is wound onto the sprocket.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a side view of a sprocket made in accordance with the present invention and showing a ball-chain for use therewith.

FIG. 2. is a perspective view of a sprocket and ball-chain combination made in accordance with the present invention.

FIG. 3. is a side view of the sprocket shown in figure one showing the relationship between the sprocket and ball-chain components as the ball-chain is wound onto the sprocket.

FIG. 4. is a side sectional view of the sprocket portion of the present invention showing a single ball in a ball-chain contained in one of the pockets of the sprocket.

FIG. 5. is a cross sectional view of the pocket portion of a prior art sprocket showing a ball about to be inserted into the pocket portion.

FIG. 6. is a cross sectional view of the pocket portion shown in FIG. 5 with the ball fully inserted into the pocket.

FIG. 7. is a cross sectional view of the pocket portion of the pocket portion of the sprocket made in accordance with the present invention showing a ball about to be inserted into the pocket portion.

FIG. 8. is a cross sectional view of the pocket portion shown in FIG. 7 with the ball fully inserted into the pocket portion.

In the drawings like characters of reference indicate corresponding parts in the different figures.

### DETAILED DESCRIPTION OF THE INVENTION

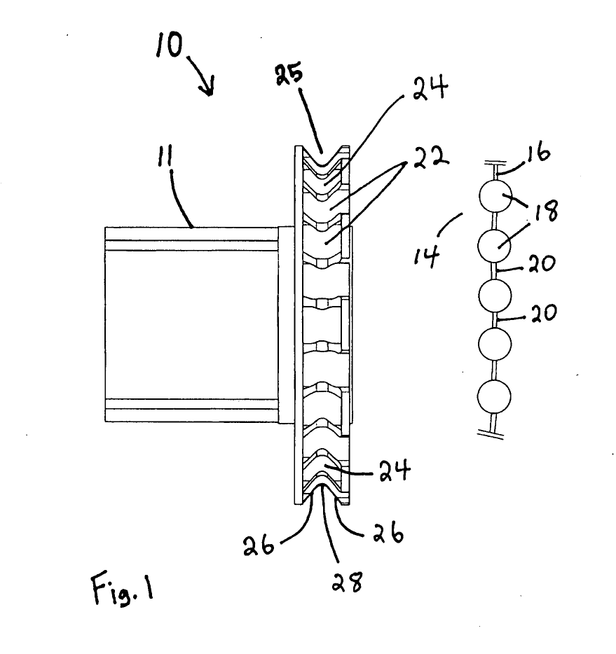

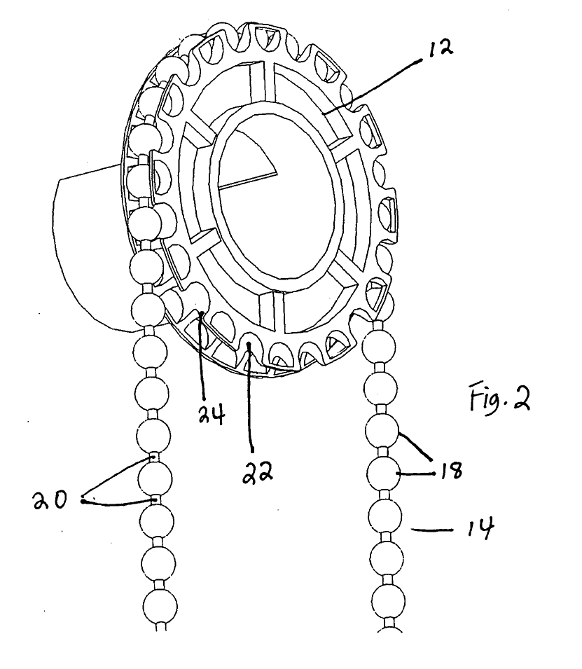

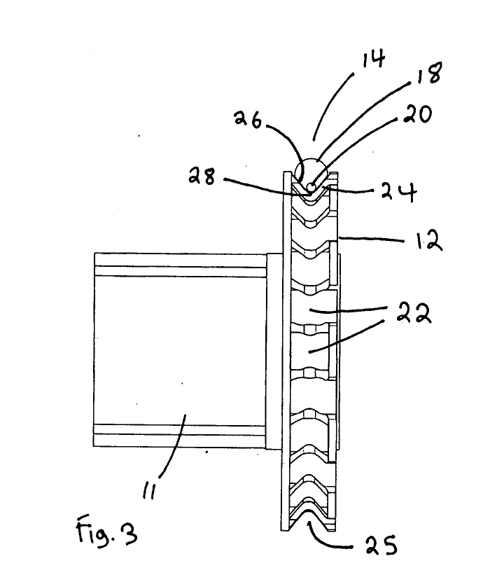

Referring firstly to FIG. 1, a ball-chain drive made in accordance with the present invention, shown generally as item 10, consists of a sprocket 12 mounted on a shaft 11 and coupled to ball-chain 14. Ball chain 14 consists of a flexible elongated cord 16 onto which spherical balls (or beads) 18 are formed. Beads 18 are spaced equally along cord 16 and separated from each other by cord segments 20, of equal length. Sprocket 12 has a plurality of peripheral pockets 22 separated from each other by walls 24. V shaped notch 25 is formed on walls 24 and includes sides 26 and meniscus 28. Pockets 22 are dimensioned and configured to mesh with ball-chain 14 as illustrated in FIG. 2. In particular, pockets 22 are each dimensioned to snugly receive balls 18. As best seen in FIG. 3, V shaped notch 25 is dimensioned such that cord-segments 20 do not rub against sides 26 and only touches meniscus 28. This permits balls 18 to enter pockets 22 more smoothly and quietly.

Referring now to FIG. 4, balls 18 have outside diameter 40 and outside circumference 42. Pockets 22 have inside diameter 34 and inside circumference 32. Inside diameter 34 is preferably equal to outside diameter 40 such that balls 18 fit snugly in pockets 22. Inside circumference 32 is preferably greater than 18020 of circumference 42 such that opening 36 of each pocket 22 is slightly smaller than outside diameter 40. This means that when balls 18 are inserted into pockets 22, the ball is held within the pocket and does not fall out. Only when chain 14 is pulled do balls 18 come out of pockets 22. It has been discovered that this arrangement greatly reduces the sound that ball-chain 14 and sprocket 12 make when the ball-chain is engaged by a user.

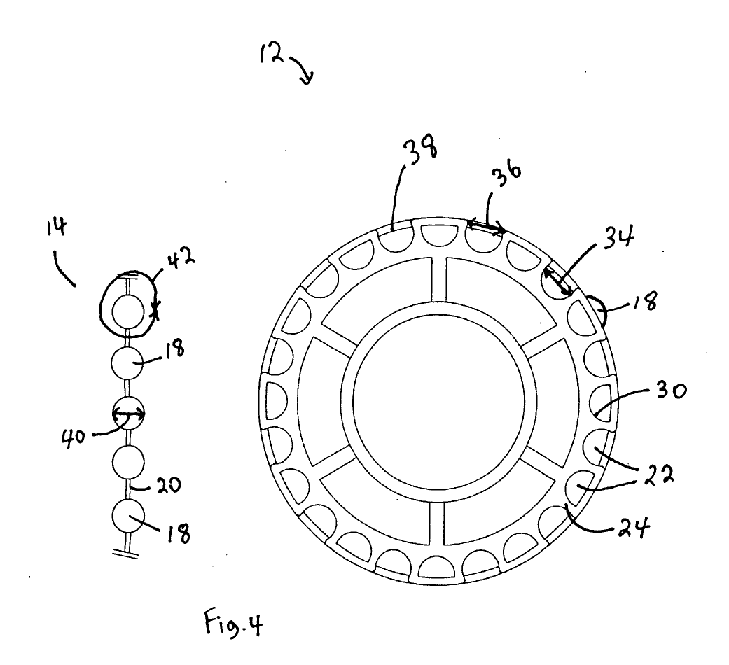

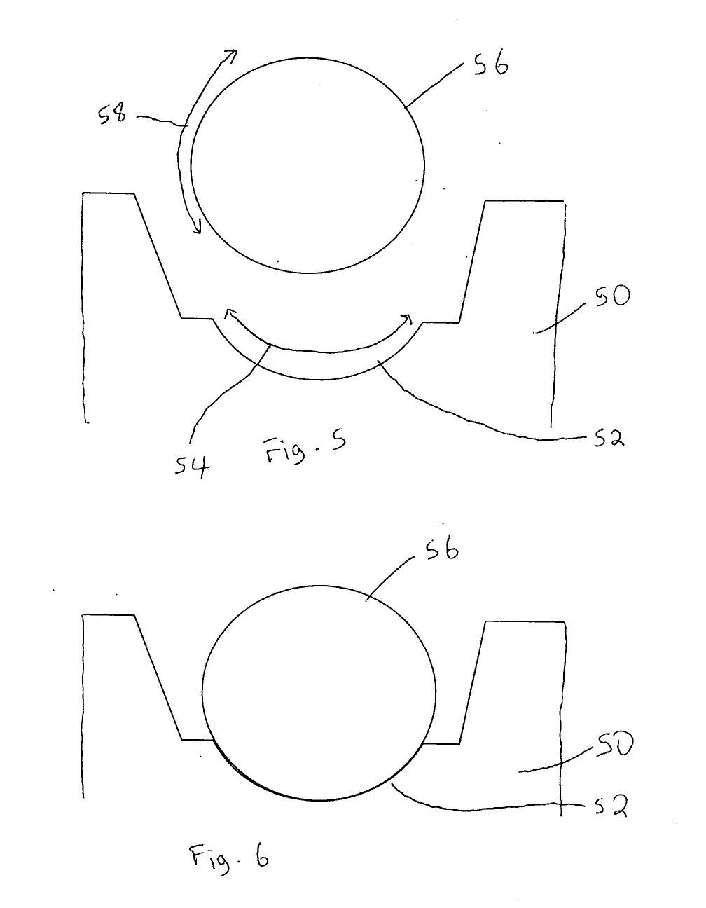

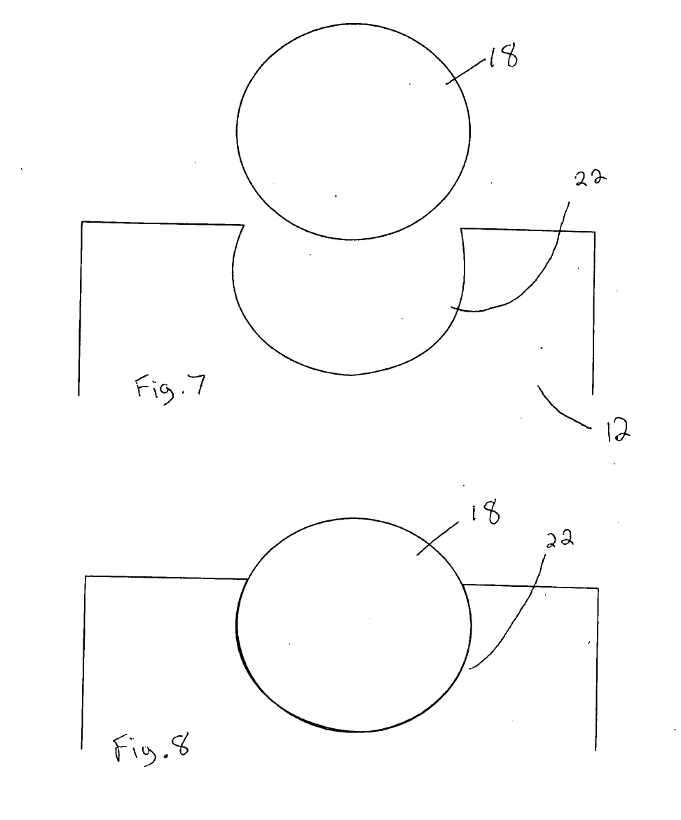

As shown in FIGS. 5 and 6, prior art ball-chain drives (not shown) used sprocket 50 having pockets 52. The inside circumference 54 of pocket 52 is less than 180° of the outside circumference 58 of ball 56. As a result, when ball 56 is fully inserted into pocket 52, only a small portion of ball 56 is contained in pocket 52 and the ball can rattle inside pocket 52. As shown in FIGS. 7 and 8, pocket 22 has an internal circumference greater than 180° of ball 18 so that when the ball is fully inserted into pocket 22, the ball is held snugly in the pocket and cannot rattle. As a result, the sprocket 12 is quieter in operation.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A ball-chain drive for use with a roll-up blind comprising:
a ball-chain comprising a cord with a plurality of regularly spaced spherical balls formed thereon;
a sprocket having a plurality of regularly spaced peripheral pockets, the pockets being configured to mesh with the balls of the ball chain, the pockets each being dimensioned to snugly receive each of the balls, and wherein the pockets each have an internal circumference greater than 180° of an external circumference of each of the balls.

2. A ball-chain drive for use with a roll-up blind comprising:
a ball-chain comprising a cord with a plurality of regularly spaced spherical balls formed thereon, each of the balls being separate by a segment of cord;
a sprocket having a plurality of regularly spaced peripheral pockets, the pockets being configured to mesh with the balls of the ball chain, the pockets being separated from each other by a plurality of walls, each wall having a V shaped notch formed thereon having sides and a meniscus, the pockets and the V shaped notch both being dimensioned such that the segments of cord do not touch the sides of the V shaped notch when the ball-chain is wound onto the sprocket.

3. The ball-chain drive of claim 2 wherein the V shaped notch is dimensioned such that the segment of cord only touches the meniscus of the V shaped notch.

4. The ball-chain drive of claim 1 wherein the pockets are separated from each other by a plurality of walls, each wall having a V shaped notch formed thereon having sides and a meniscus, the pockets and the V shaped notch both being dimensioned such that the segments of cord do not touch the sides of the V shaped notch when the ball-chain is wound onto the sprocket.

5. The ball-chain drive of claim 4 wherein the V shaped notch is dimensioned such that the segment of cord only touches the meniscus of the V shaped notch.
